(19) United States
(12) Patent Application Publication
(10) Pub. No.: US 2025/0358653 A1
(43) Pub. Date: Nov. 20, 2025

(54) MITIGATING THROUGHPUT DEGRADATION DURING RADIO RESOURCE MANAGEMENT CONFIGURATION

(71) Applicant: QUALCOMM Incorporated, San Diego, CA (US)

(72) Inventors: Akash KUMAR, Hyderabad (IN); Abhilasha NAGPAL, NOIDA (IN); Eswara Venkata Narasimha Muthyala Prasad BAHADURSHA, Hyderabad (IN); Jaweed AKHTAR, Hyderabad (IN)

(21) Appl. No.: 18/663,412

(22) Filed: May 14, 2024

(51) Int. Cl. H04W 24/10; H04L 5/00; H04W 72/02; H04W 72/0453

(52) U.S. Cl. CPC H04W 24/10; H04L 5/001; H04W 72/02; H04W 72/0453

(57) ABSTRACT

Methods, systems, and devices for wireless communications are described. A method for wireless communications at a user equipment (UE) is described, including receiving, from a network entity, signaling that configures one or more measurement resources for a plurality of measurement objects, wherein the measurement resources are based at least in part on a current radio frequency resource allocation and a baseband resource allocation for at least a first component carrier of a plurality of component carriers. The method may further include performing measurements during the measurement resources on the first component carrier during a first time period based on a reconfiguration of the measurement resources to change a quantity of measurement gaps during communications by the UE on a second component carrier. The method may also include communicating on the second component carrier of the plurality of component carriers during at least a portion of the first time period.

### FIELD OF TECHNOLOGY

The following relates to wireless communications, including mitigating throughput degradation during radio resource management configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support mitigating throughput degradation during radio resource management configuration. For example, the described techniques provide for a UE to be able to reconfigure resource allocations on a per component carrier basis. The UE may be in carrier aggregation mode and may be configured with one or more measurement objects to measure during one or more measurement gaps. The techniques described herein enable the UE and network to reduce the number of measurement gaps needed on some component carriers during the measurements. This reduces the need for gap-based measurements, which helps improve throughput and user experience.

A method for wireless communications by a UE is described. The method may include performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier and communicating, with a network entity, on the second component carrier of the set of multiple component carriers during at least a portion of the first time period.

A UE for wireless communications is described. The UE may include one or more memories storing processor executable code, and one or more processors coupled with the one or more memories. The one or more processors may individually or collectively be operable to execute the code to cause the UE to perform one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier and communicate, with a network entity, on the second component carrier of the set of multiple component carriers during at least a portion of the first time period.

Another UE for wireless communications is described. The UE may include means for performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier and means for communicating, with a network entity, on the second component carrier of the set of multiple component carriers during at least a portion of the first time period.

A non-transitory computer-readable medium storing code for wireless communications is described. The code may include instructions executable by one or more processors to perform one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier and communicate, with a network entity, on the second component carrier of the set of multiple component carriers during at least a portion of the first time period.

Some examples of the method, UEs, and non-transitory computer-readable medium described herein may further include operations, features, means, or instructions for transmitting, to the network entity, signaling that indicates a measurement gap of the one or more measurement of at least one of the set of multiple measurement objects of the UE.

Some examples of the method, UEs, and non-transitory computer-readable medium described herein may further include operations, features, means, or instructions for determining a respective throughput degradation level for each component carrier of the set of multiple component carriers based on the one or more measurement resources and the current radio frequency resource allocation and the baseband resource allocation for at least the first component carrier and the second component carrier of the set of multiple component carriers, determining a first subset of measurement objects of the set of multiple measurement objects support gapless measurement based on the respective throughput degradation level for each component carrier associated with each measurement object of the first subset of measurement objects being less than a degradation threshold, and transmitting, to the network entity, signaling that indicates a gapless measurement capability of the UE for the first subset of measurement objects.

In some examples of the method, UEs, and non-transitory computer-readable medium described herein, determining the first subset of measurement objects may include operations, features, means, or instructions for reconfiguring the one or more measurement resources for each measurement object of the first subset of measurement objects.

Some examples of the method, UEs, and non-transitory computer-readable medium described herein may further include operations, features, means, or instructions for receiving signaling that reconfigures the one or more measurement resources for the set of multiple measurement objects based on the gapless measurement capability of the UE for the first subset of measurement objects.

Some examples of the method, UEs, and non-transitory computer-readable medium described herein may further include operations, features, means, or instructions for determining the reconfiguration of the one or more measurement resources by jointly allocating radio frequency resources and baseband resources from the current radio frequency resource allocation and the baseband resource allocation for the first component carrier and the second component carrier.

Some examples of the method, UEs, and non-transitory computer-readable medium described herein may further include operations, features, means, or instructions for determining a respective channel performance for each of the set of multiple component carriers, where the reconfiguration of the one or more measurement resources may be based on the respective channel performance for each of the set of multiple component carriers.

In some examples of the method, UEs, and non-transitory computer-readable medium described herein, performance of at least one of the one or more measurements during a pre-reconfiguration state of the UE may be during a pre-reconfiguration measurement gap that interferes with communications by the UE on the second component carrier.

Some examples of the method, UEs, and non-transitory computer-readable medium described herein may further include operations, features, means, or instructions for communicating on the second component carrier may be during at least the portion of the first time period instead of pausing communications on the second component carrier during the pre-reconfiguration measurement gap.

In some examples of the method, UEs, and non-transitory computer-readable medium described herein, the quantity of measurement gaps during communications by the UE on the second component carrier may be reduced with respect to a quantity of measurement gaps of a pre-reconfiguration state of the UE.

A method for wireless communications by a network entity is described. The method may include receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers and transmitting, to the UE, signaling that indicates a reconfiguration of the one or more measurement resources for the first subset of measurement objects of the set of multiple measurement objects based on the gapless measurement capability of the UE for the first subset of measurement objects.

A network entity for wireless communications is described. The network entity may include one or more memories storing processor executable code, and one or more processors coupled with the one or more memories. The one or more processors may individually or collectively be operable to execute the code to cause the network entity to receive, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers and transmit, to the UE, signaling that indicates a reconfiguration of the one or more measurement resources for the first subset of measurement objects of the set of multiple measurement objects based on the gapless measurement capability of the UE for the first subset of measurement objects.

Another network entity for wireless communications is described. The network entity may include means for receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers and means for transmitting, to the UE, signaling that indicates a reconfiguration of the one or more measurement resources for the first subset of measurement objects of the set of multiple measurement objects based on the gapless measurement capability of the UE for the first subset of measurement objects.

A non-transitory computer-readable medium storing code for wireless communications is described. The code may include instructions executable by one or more processors to receive, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers and transmit, to the UE, signaling that indicates a reconfiguration of the one or more measurement resources for the first subset of measurement objects of the set of multiple measurement objects based on the gapless measurement capability of the UE for the first subset of measurement objects.

Some examples of the method, network entities, and non-transitory computer-readable medium described herein may further include operations, features, means, or instructions for receiving, from the UE, one or more measurement reports related to the set of multiple measurement objects.

### BRIEF DESCRIPTION OF THE DRAWINGS

FIG. 1 shows an example of a wireless communications system that supports mitigating throughput degradation during radio resource management configuration in accordance with one or more aspects of the present disclosure.

FIG. 2 shows an example of a network architecture that supports mitigating throughput degradation during radio resource management configuration in accordance with one or more aspects of the present disclosure.

FIG. 3 shows an example of a diagram that supports mitigating throughput degradation during radio resource management configuration in accordance with one or more aspects of the present disclosure.

FIG. 4 shows an example of a process flow that supports mitigating throughput degradation during radio resource management configuration in accordance with one or more aspects of the present disclosure.

FIGS. 5 and 6 show block diagrams of devices that support methods to mitigate throughput degradation during radio resource management configuration in accordance with one or more aspects of the present disclosure.

FIG. 7 shows a block diagram of a communications manager that supports methods to mitigate throughput degradation during radio resource management configuration in accordance with one or more aspects of the present disclosure.

FIG. 8 shows a diagram of a system including a device that supports methods to mitigate throughput degradation during radio resource management configuration in accordance with one or more aspects of the present disclosure.

FIGS. 9 and 10 show block diagrams of devices that support methods to mitigate throughput degradation during radio resource management configuration in accordance with one or more aspects of the present disclosure.

FIG. 11 shows a block diagram of a communications manager that supports methods to mitigate throughput degradation during radio resource management configuration in accordance with one or more aspects of the present disclosure.

FIG. 12 shows a diagram of a system including a device that supports methods to mitigate throughput degradation during radio resource management configuration in accordance with one or more aspects of the present disclosure.

FIGS. 13 through 15 show flowcharts illustrating methods that support methods to mitigate throughput degradation during radio resource management configuration in accordance with one or more aspects of the present disclosure.

### DETAILED DESCRIPTION

During wireless communications, a user equipment (UE) may take various measurements of signals in wireless channels to determine the current health, performance, and channel conditions of a wireless communications system. The measurements may help the network and the UE make decisions regarding resource allocation, resource management, carrier aggregation, dual connectivity, cell selection and handover, and the like, which may help achieve a quality of service level. The measurements may be on downlink channels from the network to the UE or on sidelink channels between the UE and other UEs.

A UE may be configured to perform intra-frequency or inter-frequency (IFREQ) NR measurements or inter radio access technology (IRAT) measurements, for one or more measurement objects. The UE may measure different signals, such as a synchronization signal block (SSB) and a channel state information reference signal (CSI-RS). Example measurement objects may include, among others, an evolved universal mobile telecommunication system terrestrial radio access (E-UTRA) reference signal received power (RSRP), reference signal received quality (RSRQ), reference signal signal-to-interference-plus-noise ratio (RS-SINR), UTRA frequency division duplexing (FDD) common pilot channel (CPICH) received signal code power (RSCP), UTRA FDD carrier received signal strength indicator (RSSI), the ratio between the received energy from the pilot signal CPICH per chip (Ec) to the noise density (No) (CPICH Ec/No), wireless local-area network (WLAN) RSSI for handovers to Wi-Fi, reference signal Time difference (RSTD) for E-UTRA (e.g., a relative timing difference between an E-UTRA cell and the E-UTRA reference cell), and the like. Measurement objects for sidelink channels may include, for example, sidelink RSSI, sidelink channel occupancy ratio (SL CR), sidelink channel busy ratio (SL CBR), physical sidelink broadcast channel (PSBCH) RSRP, physical sidelink shared channel (PSSCH) RSRP, and physical sidelink control channel (PSCCH) RSRP, and the like.

The network may configure one or more measurement gaps for the UE to measure the configured measurement objects and to send back measurement reports to the network to support mobility scenarios. Some of the measurement gaps may be different from each other. For example, the measurement gaps may be for different technologies, belong to different bands, or belong to different frequencies. During the duration of the measurement gap, the network discontinues scheduling on any tuned carriers to allow the UE to retune to the configured measurement object's radio frequency configuration. For example, the UE may retune the band, frequency, and bandwidth for the configured measurement object.

The network may not expect the UE to have enough receivers in order to perform measurements both on the serving cell as well as on the measurement objects. Thus, during the measurement gaps, the network may discontinue scheduling on the currently tuned or active carriers, which allows the UE to reuse the same set of resources, retune them to the band frequency of the measurement objects, and perform the measurements. However, this gap duration for which scheduling is paused leads to degradation in throughput compared to throughput achievable if the scheduling was to be continued. The degradation may be due to a periodic interruption to the actual scheduling that is ongoing on the currently active carriers during the gap duration. Depending on the mobility configuration, as more and more measurement objects are configured or the periodicity of the measurements is increased, the total throughput degradation from the maximum achievable may worsen. There may be significant degradation to the maximum achievable throughput specifically in mobility scenarios.

In some scenarios, the UE can send an information element, NeedForGap, that indicates, on a per measurement object basis, that the UE supports a gapless measurement capability that allows the tuned carriers to continue to operate. Thus, the network may continue to schedule carriers that are identified in the NeedForGap support. The information element may be sent in an RRC response message. However, the information element NeedForGap does not allow gapless operation on a per carrier basis. Thus, in carrier aggregation situations, even if there is path or resource conflict of the measurement object with at least one of the serving cells or frequency bands, the UE is unable to perform the gapless measurement. Thus, while the network provides the UE with this flexibility, it cannot be used on a per-carrier basis.

Techniques described herein provide methods and systems to reduce the need for gap based measurements, which will help improve throughput and user experience. The downlink and uplink throughput can be improved by preventing gap-based measurements and facilitating gapless procedures. For example, the UE may reconfigure the RF resource allocations, the baseband resource allocations, and the baseband path to allow for some component carriers to continue to be scheduled while measurements are made on another component carrier. For example, for a given configuration on a given frequency, the bandwidth resources may be located independent of the measurement configurations, the RF and baseband resources may be allocated to get improved throughput performance.

Further techniques described herein provide for the UE to perform path assignments to reduce a number of carriers having resource conflicts with measurement objects, thus reducing the number of measurement gaps that may be needed. The UE may be configured by the network with a number of measurement objects using a default path assignment. The UE may compute a total measurement gap duration and throughput degradation on the serving cells with the default path assignment, and determine how many measurement objects would require measurement gaps. The UE may compare an estimated degradation amount to a degradation threshold for each possible path allocation. The UE may select a best possible path allocation for all of the available paths, given the channel conditions and measurement objects. The UE may retune the carriers to the selected path allocation, and report gapless capability for the respective measurement objects based on the new path allocation.

Aspects of the disclosure are initially described in the context of wireless communications systems. Aspects of the disclosure are illustrated by and described with reference to diagrams of network architecture, process flows, and timing and frequency diagrams. Aspects of the disclosure are further illustrated by and described with reference to apparatus diagrams, system diagrams, and flowcharts that relate to mitigating throughput degradation during radio resource management configuration.

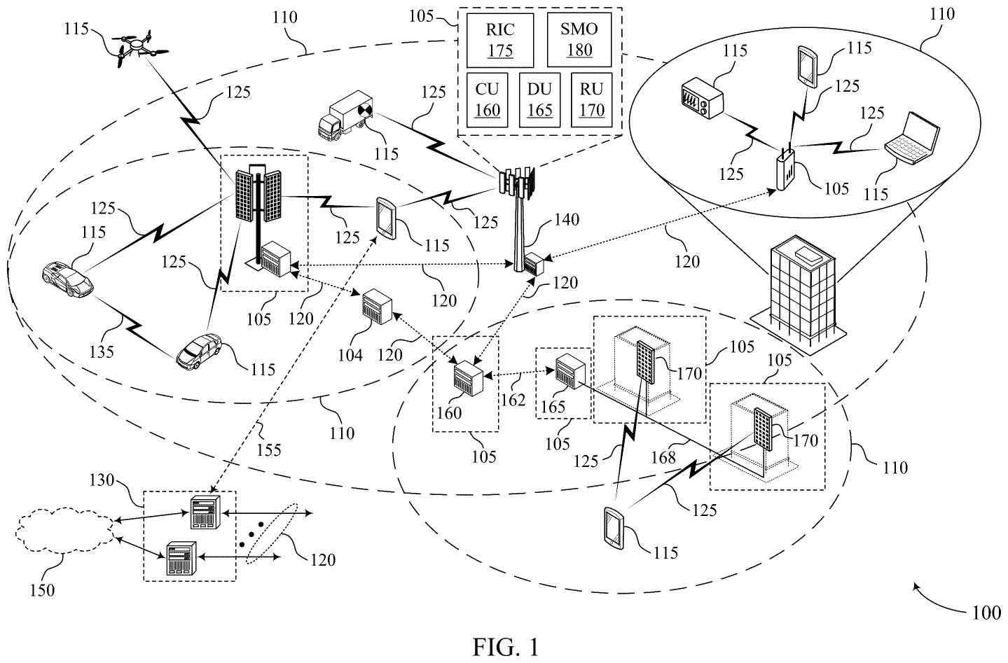

FIG. 1 shows an example of a wireless communications system 100 that supports mitigating throughput degradation during radio resource management configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both FDD and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an E-UTRA absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein include a UE receiving, from a network entity, signaling that configures one or more measurement resources for a plurality of measurement objects, wherein the one or more measurement resources are based at least in part on a current radio frequency resource allocation and a baseband resource allocation for at least a first component carrier of a plurality of component carriers. The UE may perform one or more measurements during the one or more measurement resources on the first component carrier during a first time period based on a reconfiguration of the one or more measurement resources to change a quantity of measurement gaps during communications by the UE on a second component carrier. The UE may also communicate on the second component carrier of the plurality of component carriers during at least a portion of the first time period.

Further techniques described herein include a network entity transmitting, to a UE, signaling that configures one or more measurement resources for a plurality of measurement objects, wherein the one or more measurement resources are based at least in part on a current radio frequency resource allocation and a baseband resource allocation for at least a first component carrier and a second component carrier of a plurality of component carriers. The network entity may receive, from the UE, signaling that indicates a gapless measurement capability of the UE for a first subset of measurement objects of the plurality of measurement objects. The network entity may transmit, to the UE, signaling that indicates a reconfiguration of the one or more measurement resources for the first subset of measurement objects based at least in part on the gapless measurement capability of the UE for the first subset of measurement objects.

By retuning the component carriers that may otherwise have had require a measurement gap, throughput and user experience can be improved. For example, the DL/UL throughput can be improved by preventing or reducing the number of gap-based measurements and facilitating gapless procedures. This can be supported through intelligent radio frequency resource allocations and baseband path/resource allocations for the source wireless device (a network entity or UE) and the target wireless device (another network entity or UE).

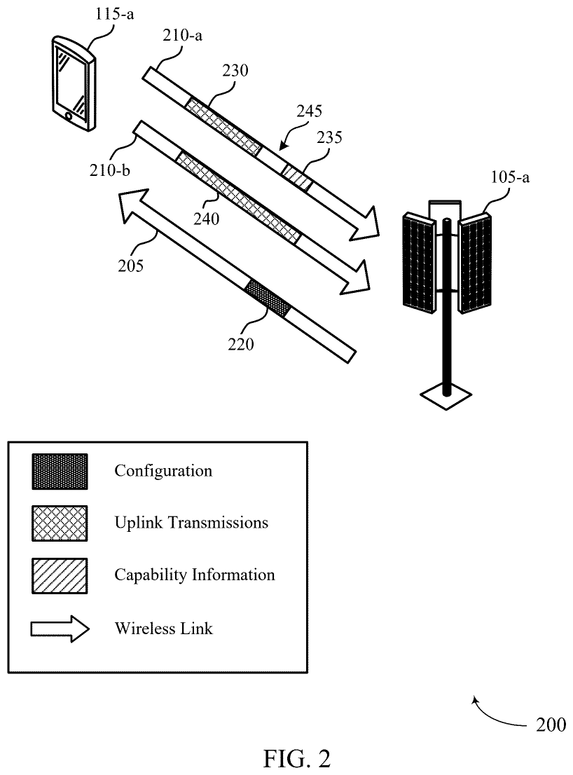

FIG. 2 shows an example of a network architecture 200 that supports mitigating throughput degradation during radio resource management configuration in accordance with one or more aspects of the present disclosure. The network architecture 200 may implement or be implemented by aspects of the wireless communications system 100. For example, the network architecture 200 illustrates a system including a network entity 105-a and a UE 115-a, which may be similar to or include aspects of the network entity 105 and the UE 115 as illustrated by or described with reference to FIG. 1. In other examples, the communications and messages described herein can be sent from or between different wireless devices (e.g., between two or more UEs, between two or more network entities, or combinations thereof).

The UE 115-a may be configured with multiple component carriers for carrier aggregation communications. FIG. 2 shows the UE 115-a communicating with the network entity 105-a via two component carriers, 210-a and 210-b (collectively referred to as component carriers 210). In other examples, the UE 115-a may be configured with different numbers of component carriers as shown in FIG. 2. For simplicity of FIG. 2, the network entity 105-a has been shown to have a single downlink 205 to the UE 115-a, however, the network entity 105-a may communicate using multiple component carriers as well.

The network entity 105-a may send a configuration message 220 to the UE 115-a via the downlink 205. The configuration message 220 may include one or more different configuration messages. The configuration message 220 may configure one or more measurement resources for one or more measurement objects. The configuration message 220 may also configure the UE 115-a with a radio frequency resource allocation and baseband resource allocation for at least one component carrier of a set of component carriers. The network entity 105-a may base the one or more measurement resources on a current radio frequency resource allocation and a baseband resource allocation for the component carrier. For example, the network entity 105-a may configure the component carrier 210-a with one or more measurement objects and corresponding measurement gaps for the other component carriers, such as the component carrier 210-b, during the duration of the measurement of the measurement object, and signal this to the UE 115-a in the configuration message 220.

The UE 115-a may send uplink transmissions via the component carriers 210 to the network entity 105-a. For example, the UE 115-a may send capability information 235 to the network entity 105-a via component carrier 210-a. The capability information 235 may include an indication that the UE 115-a supports gapless measurement for one or more component carriers 210. For example, the capability information 235 may indicate that the resources for the component carrier 210-b can be retuned such that a measurement gap is not needed for the component carrier 210-b while the measurement is made on the component carrier 210-a. In other examples, other information may be included in the capability information 235.

At time 245 in the uplink carrier component 210-a, the UE 115-a may take one or more measurements of one or more measurement objects. During time 245, the UE 115-a may be simultaneously communicating on the component carrier 210-b. For example, the UE 115-a may be transmitting an uplink message 240 on the component carrier 210-b while the UE 115-a is performing a measurement of a measurement object. In other examples, the UE 115-a may receive on the component carrier 210-b during the measurement at time 245, such as receive a downlink message from the network entity 105-a or an uplink message from another UE.

After the measurements are performed during time 245, the UE 115-a may continue to communicate via the component carrier 210-a. For example, the UE 115-a may transmit an uplink message 230 to the network entity 105-a. The uplink message 230 may include a measurement report, which provides an indication of the one or more measurements taken at time 245. In other examples, the UE 115-a may receive on the component carrier 210-a after the measurement at time 245, such as receive a downlink message from the network entity 105-a or an uplink message from another UE.

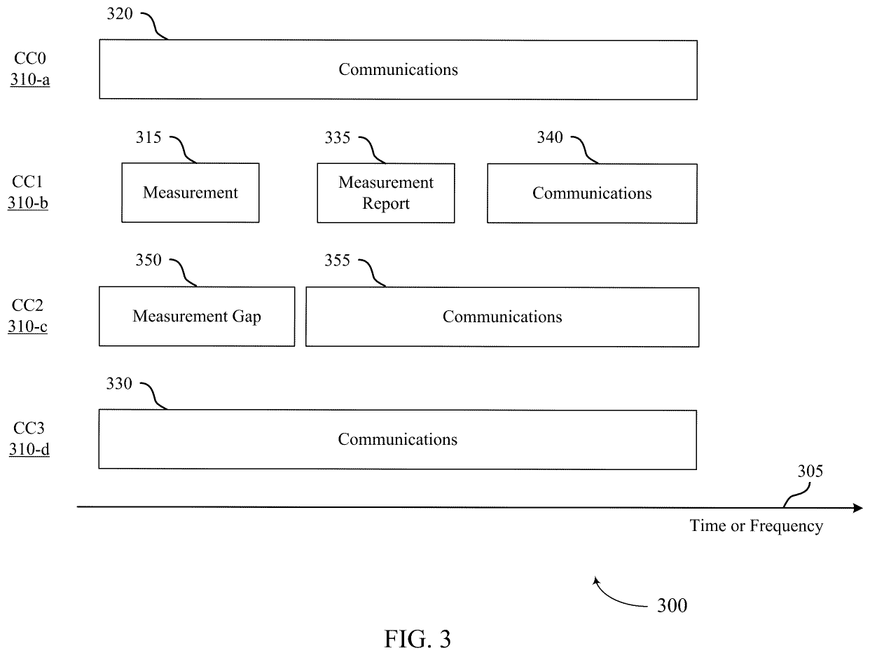

FIG. 3 shows an example of a diagram 300 that supports mitigating throughput degradation during radio resource management configuration in accordance with one or more aspects of the present disclosure. The diagram 300 may implement or be implemented by aspects of the wireless communications system 100. For example, the diagram 300 may be implemented by a UE, such as the UE 115 as illustrated by or described with reference to FIGS. 1 and 2.

An axis 305 of the diagram 300 may represent time or frequency. As described herein, FIG. 3 is explained as if the axis 305 related to time. However, the same concepts may apply to frequency as well.

Four component carriers 310-a, 310-b, 310-c, and 310-d (collectively referred to as component carriers 310) are illustrated in FIG. 3, although other numbers of component carriers may be used in other examples. In the example of FIG. 3, the UE may be configured to perform a measurement 315 on component carrier 310-b. The network may have configured the UE such that measurement gaps would be available for the component carriers 310-a, 310-c, and 310-d during the measurement duration. The network may be able to cease communications during the time when the UE performs the measurements.

However, according to techniques described herein, the UE may be able to perform gapless measurement for at least some of the component carriers. For example, it may be possible for the UE to retune the resources for the component carriers 310-a and 310-d such that no gap in communications is required during the measurement 315 on component carrier 310-b. The UE may independently retune the resources for the component carriers 310-a and 310-d without notifying the network, or it may send a capability message to the network to indicate that the component carriers 310-a and 310-d can support gapless measurement. In the later case, the network may continue to schedule the component carriers 310-a and 310-d during the measurement 315. As such, the component carriers 310-a may perform communications 320 and the component carrier 310-d may perform communications 330 during the measurement 315.

The UE may have determined that there is no good alternative path or retuning of resources to have gapless measurement for the component carrier 310-c. Thus, the component carrier 310-c may still be subject to having a gap in communications during the measurement 315. As such, during the measurement 315, the component carrier 310-c has a measurement gap 350, and ceases to receive or transmit at that time. Once the measurement gap 350 is complete, the component carrier 310-c may resume communications 355.

The UE may make measurements 315 for the one or more measurement objects associated with the component carrier 310-b. Once the measurements 315 are made, the UE may transmit one or more measurement reports 335 associated with the measurements 315. In some examples, the measurement reports 335 may be transmitted on different component carriers 310 or to one or more different wireless devices. Once the measurement reports 335 are complete, the component carrier 310-b may resume communications 340.

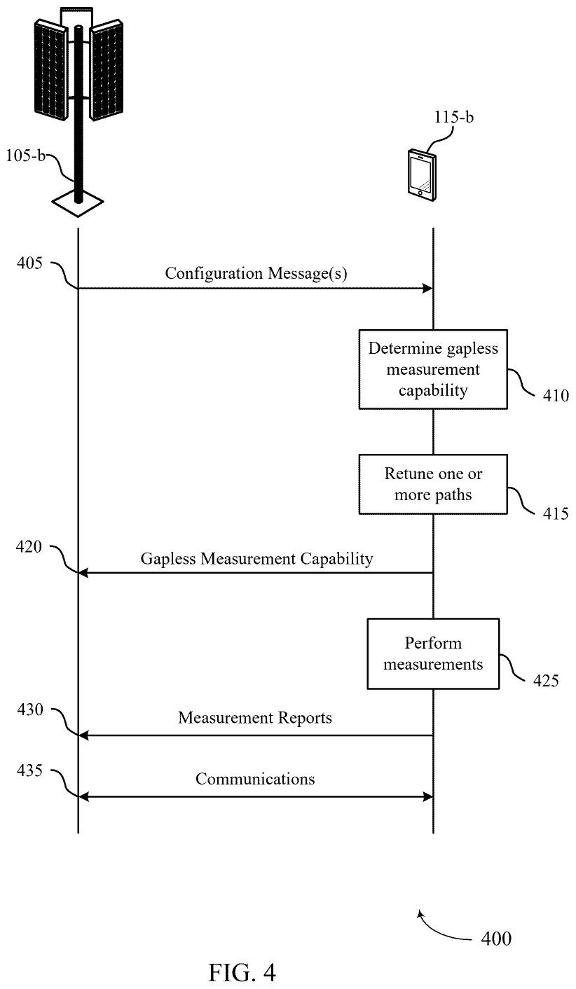

FIG. 4 shows an example of a process flow 400 that supports mitigating throughput degradation during radio resource management configuration in accordance with one or more aspects of the present disclosure. The process flow 400 may implement or be implemented by aspects of the wireless communications system 100. For example, the process flow 400 illustrates a system including a network entity 105-b and a UE 115-b, which may be similar to or include aspects of the network entity 105 and the UE 115 as illustrated by or described with reference to FIGS. 1 and 2. In other examples, the communications and messages described herein can be sent from or between different wireless devices (e.g., between two or more UEs, between two or more network entities, or combinations thereof). The UE 115-b and the network entity 105-b may be configured with multiple component carriers for carrier aggregation communications.

The network entity 105-b may send a configuration message 405 to the UE 115-b. The configuration message 405 may include one or more different configuration messages. The configuration message 405 may also configure the UE 115-b with a radio frequency resource allocation and baseband resource allocation for at least one component carrier of a set of component carriers. The network entity 105-b may base the one or more measurement resources on a current radio frequency resource allocation and a baseband resource allocation for the component carrier. For example, the network entity 105-b may configure the component carrier 210-a with one or more measurement objects and corresponding measurement gaps for the other component carriers, such as the component carrier 210-b, during the duration of the measurement of the measurement object, and signal this to the UE 115-b in the configuration message 405. In some examples, the configuration message 405 may configure one or more measurement resources for one or more measurement objects. In other examples, the UE 115-b determines the one or more measurement resources for the one or more measurement objects, based at least in part on selection algorithms or RF receiver sensitivity performance.

For a given configuration on a given frequency, the bandwidth resources may be located independent of the measurement configurations, the RF and baseband resources may be allocated to improve performance. Existing RF and baseband resource allocation do not assist in gapless measurements primarily because the source or serving cell path allocation may be based on a preferred path assignment using offline knowledge of RF performance across the available paths. Example target path selection may be a static path allocation scheme that prioritizes similar path allocations as the source paths in terms of digital and analog components, in order to reuse the configuration of the source during the measurement gap as the network would not schedule communications during the gap duration.

Techniques described herein propose the current RF and baseband resource allocation are to be allocated jointly, using the serving and configured measurement objects' information (e.g., band, bandwidth, frequency, etc.) to intelligently determine a path allocation that allows a maximum number of measurement objects to be measured in a gapless fashion. For example, the UE 115-b may perform a joint resource allocation using the current serving cell configuration and the different measurement gap configurations. The technique described facilitate gapless measurements through intelligent target path allocation schemes wherein the network can continue scheduling for the tuned carriers in the measurement gap duration.

The UE 115-b may utilize artificial intelligence or machine learning to compare different factors among the alternative pathways to perform a gapless measurement, and select those pathways that lead to the highest performance. The highest performance may be determined by a highest throughput, a highest quality of service, or through some other metric.

An example is provided. When the UE 115-b camps on a frequency band, say n28, and moves into a connected state, the path allocation on n28 is done independently to maximize the performance of n28. In an example where the UE 115-b receives the measurement configuration and the n41 measurement object is configured, the original assignment path may conflict with n28, requiring the n41 measurements to happen using measurement gaps. This may cause n28 to experience throughput degradation due to the gap. However, techniques described herein may determine the best pathway for n28 in order to maximize performance such that measurements on another frequency band, say n41, can be performed using gapless measurements.

These techniques may be performed without requiring an additional handshake procedure from the network. The techniques may also be performed without changes being made to the resources allocated to the UE 115-b. For example, the network does not have to increase the number of resources allocated to the UE 115-b. The UE 115-b may change its resource configuration without changes being made to the resource allocation. The network may not need to do anything to facilitate the UE 115-b to perform the reconfiguration. In some examples, the network may not even be aware that the UE 115-b has performed the reconfiguration. Techniques described herein may also be used in conjunction with the information element NeedForGap.

Performing an intelligent non-conflicting path allocation on n28 by checking the measurement configuration on n41 allows both component carriers to operate independently without any conflict at the underlying hardware. This allows the ‘source’ object (i.e., the tuned component carriers) to continue to stream while in parallel, the ‘target’ measurement are performed, thus saving the throughput loss during the measurement gap duration.

In another example, in an event when the gapless measurements cannot be achieved, the UE 115-b may perform an intelligent path assignment that minimizes the number of carriers having resource conflicts with the measurement objects. This reduces the number of measurement gaps required. This enables the UE 115-b and the network to open the measurement gaps on a per-carrier basis, which allows other non-conflicting carriers to continue scheduling inside the measurement gap.

As an example, the UE 115-b may camp on a cell or get configured with the configuration messages 405 to be in carrier aggregation mode. The UE 115-b may use default path assignments that are based on an offline resource allocation scheme, before any reconfiguration (e.g., conventional behavior). The network may configure the UE 115-b with the measurement configuration, using the configuration messages 405.

At 410, the UE 115-b may determine the gapless measurement capability. For example, the UE 115-b may check the bands, frequency, and bandwidth of the measurement objects according to the measurement configuration. The UE 115-b may compute a total measurement gap duration or throughput degradation on the serving cells. The UE 115-b may determine how many measurement objects require measurement gaps. The UE 115-b may check the respective measurement gap configuration for all measurement objects in the configuration. For example, the measurement gap configurations may include a measurement gap length (MGL), a measurement gap repetition period, or the like.

The UE 115-b may check if an estimated degradation for each component carrier is more than a threshold and current serving cells conditions are not sens limited (to allow an alternate path assignment consideration). The serving cell conditions being sens limited may occur when the actual current operating conditions (e.g., RSRP, SNR, etc.) are nearing an RF's path known sensitivity. Each RF path may have a fixed RF sensitivity performance over a given frequency range or frequency band. In some examples, the default assigned path may be the best path in terms of sens. Thus, in some examples, the path reassignment may be triggered only when the serving cells are not in sens limited scenario. In that case, selecting a slightly worse path in terms of sens (e.g., 1-2 dB less than the best path) may be inconsequential for signal quality. The UE 115-b may further evaluate each band, frequency, and bandwidth of the measurement objects for every possible path allocation on the serving cells and identify the best path allocation for the serving cells. The best path allocation may be the path that minimizes the total gap duration or throughput degradation.

At 415, the UE 115-b may retune each path in order to facilitate gapless (or minimize the measurement objects that conflict if complete gapless is not possible for every neighbor). In some examples, the UE 115-b may retune or reconfigure a path for only some of the measurement objects. The UE 115-b may evaluate the throughput degradation due to all measurement objects for each possible resource allocation. The UE 115-b may select one of the resource allocations based on its minimal amount of throughput impact compared with the alternative resource allocations. In some examples, the reconfiguration of resources may happen a single time during the entire measurement configuration (which contains multiple measurement objects). In other examples, the reconfiguration of resources may happen several times during the entire measurement configuration.

The UE 115-b may report gapless capability for the respective measurement objects based on the new path allocation via sending a gapless measurement capability 420. The UE 115-b may signal the gapless capability for each configured measurement object to indicate the requirement of a measurement gap for that object, and to indicate which component carriers need a measurement gap. In some examples, there may be an additional step to handshake with the network for each carrier or layer impacted.

In some examples, the process described herein can be simplified using a known deployment in a region or Argus data to preconfigure the paths to be used based on mobile country code (MCC), public land mobile network (PLMN), location of the UE, or other factors.

Once the paths are retuned to increase the number of gapless measurements, the UE 115-b may perform the measurements according to the configuration, at 425. One or more measurement reports 430 may be sent to the network entity 105-b. The UE 115-b and network entity 105-b may continue communications 435.

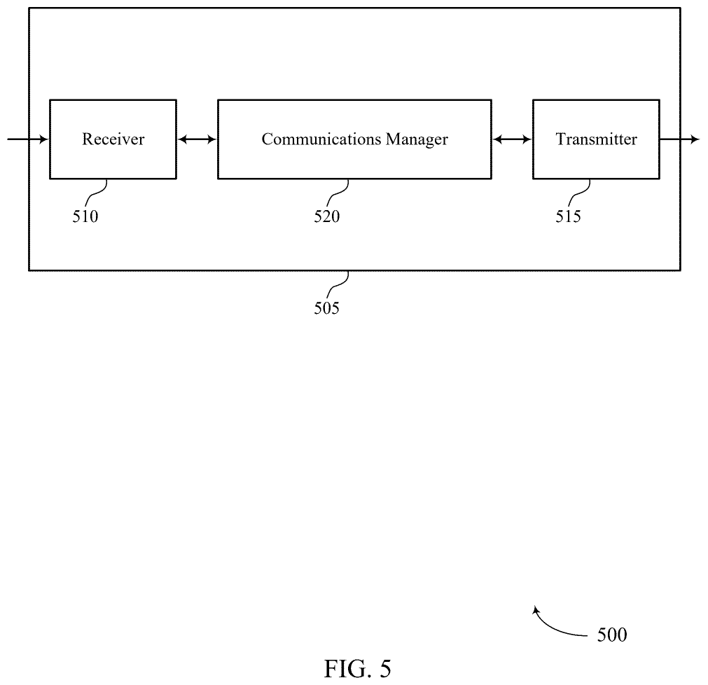

FIG. 5 shows a block diagram 500 of a device 505 that supports methods to mitigate throughput degradation during radio resource management configuration in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to methods to mitigate throughput degradation during radio resource management configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to methods to mitigate throughput degradation during radio resource management configuration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of methods to mitigate throughput degradation during radio resource management configuration as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The communications manager 520 is capable of, configured to, or operable to support a means for communicating, with a network entity, on the second component carrier of the set of multiple component carriers during at least a portion of the first time period.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

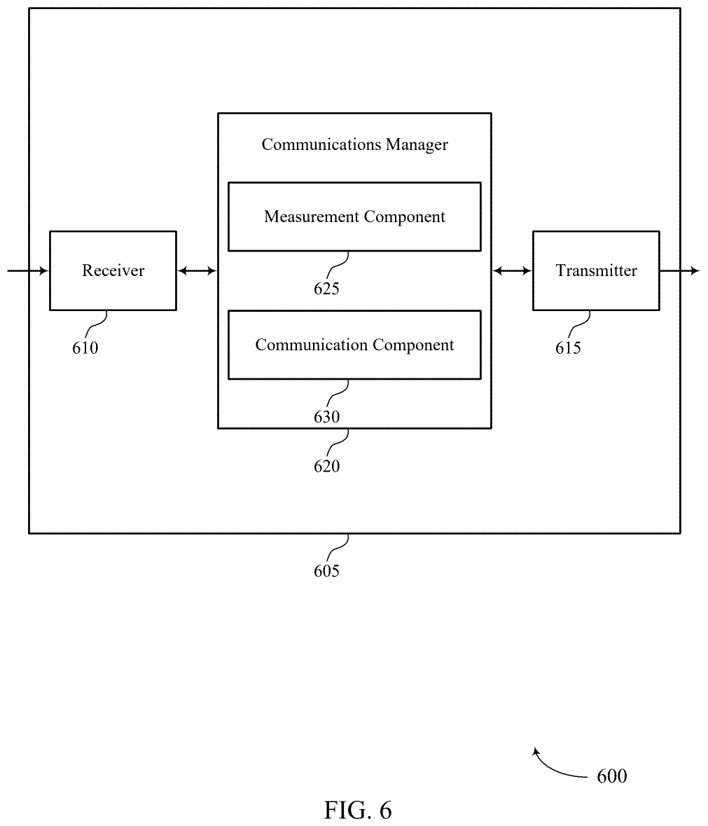

FIG. 6 shows a block diagram 600 of a device 605 that supports methods to mitigate throughput degradation during radio resource management configuration in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to methods to mitigate throughput degradation during radio resource management configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to methods to mitigate throughput degradation during radio resource management configuration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of methods to mitigate throughput degradation during radio resource management configuration as described herein. For example, the communications manager 620 may include a measurement component 625 a communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The measurement component 625 is capable of, configured to, or operable to support a means for performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The communication component 630 is capable of, configured to, or operable to support a means for communicating, with a network entity, on the second component carrier of the set of multiple component carriers during at least a portion of the first time period.

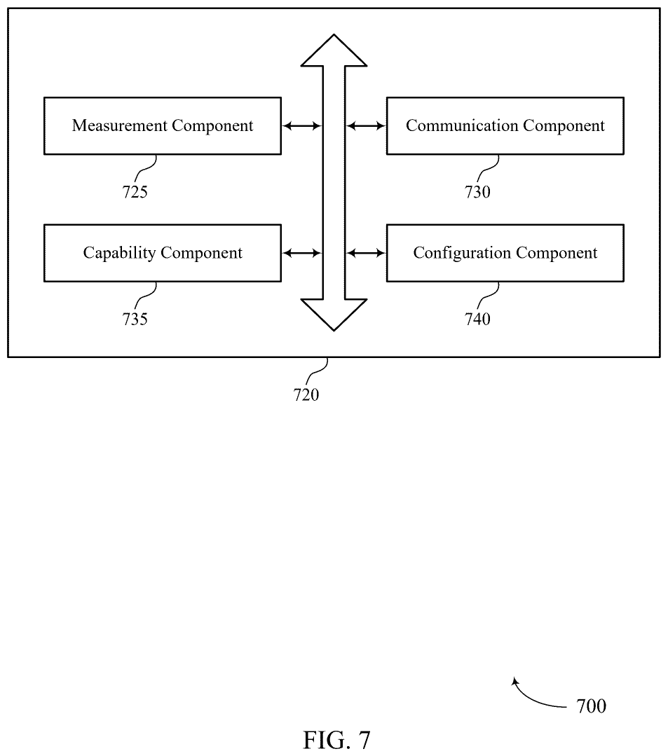

FIG. 7 shows a block diagram 700 of a communications manager 720 that supports methods to mitigate throughput degradation during radio resource management configuration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of methods to mitigate throughput degradation during radio resource management configuration as described herein. For example, the communications manager 720 may include a measurement component 725, a communication component 730, a capability component 735, a configuration component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The measurement component 725 is capable of, configured to, or operable to support a means for performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The communication component 730 is capable of, configured to, or operable to support a means for communicating, with a network entity, on the second component carrier of the set of multiple component carriers during at least a portion of the first time period.

In some examples, transmitting, to the network entity, signaling that indicates a measurement gap of the one or more measurement of at least one of the set of multiple measurement objects of the UE.

In some examples, the capability component 735 is capable of, configured to, or operable to support a means for determining a respective throughput degradation level for each component carrier of the set of multiple component carriers based on the one or more measurement resources and the current radio frequency resource allocation and the baseband resource allocation for at least the first component carrier and the second component carrier of the set of multiple component carriers. In some examples, the capability component 735 is capable of, configured to, or operable to support a means for determining a first subset of measurement objects of the set of multiple measurement objects support gapless measurement based on the respective throughput degradation level for each component carrier associated with each measurement object of the first subset of measurement objects being less than a degradation threshold. In some examples, the communication component 730 is capable of, configured to, or operable to support a means for transmitting, to the network entity, signaling that indicates a gapless measurement capability of the UE for the first subset of measurement objects.

In some examples, to support determining the first subset of measurement objects, the configuration component 740 is capable of, configured to, or operable to support a means for reconfiguring the one or more measurement resources for each measurement object of the first subset of measurement objects.

In some examples, the configuration component 740 is capable of, configured to, or operable to support a means for receiving signaling that reconfigures the one or more measurement resources for the set of multiple measurement objects based on the gapless measurement capability of the UE for the first subset of measurement objects.

In some examples, the configuration component 740 is capable of, configured to, or operable to support a means for determining the reconfiguration of the one or more measurement resources by jointly allocating radio frequency resources and baseband resources from the current radio frequency resource allocation and the baseband resource allocation for the first component carrier and the second component carrier.

In some examples, the capability component 735 is capable of, configured to, or operable to support a means for determining a respective channel performance for each of the set of multiple component carriers, where the reconfiguration of the one or more measurement resources is based on the respective channel performance for each of the set of multiple component carriers.

In some examples, performance of at least one of the one or more measurements during a pre-reconfiguration state of the UE is during a pre-reconfiguration measurement gap that interferes with communications by the UE on the second component carrier.

In some examples, communicating on the second component carrier is during at least the portion of the first time period instead of pausing communications on the second component carrier during the pre-reconfiguration measurement gap.

In some examples, the quantity of measurement gaps during communications by the UE on the second component carrier is reduced with respect to a quantity of measurement gaps of a pre-reconfiguration state of the UE.

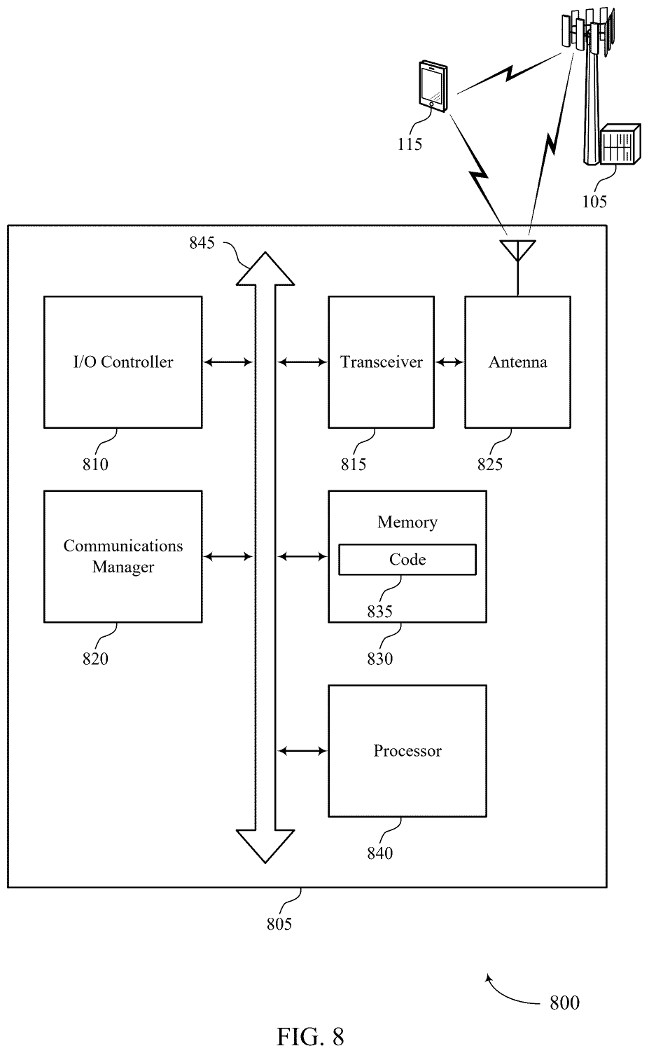

FIG. 8 shows a diagram of a system 800 including a device 805 that supports methods to mitigate throughput degradation during radio resource management configuration in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting methods to mitigate throughput degradation during radio resource management configuration). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The communications manager 820 is capable of, configured to, or operable to support a means for communicating, with a network entity, on the second component carrier of the set of multiple component carriers during at least a portion of the first time period.

By including or configuring the communications manager 820 in accordance with examples as described herein, the device 805 may support techniques for reduced latency, improved throughput, improved user experience related to improved throughput, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of mitigating throughput degradation during radio resource management configuration as described herein, or the at least one processor 840 and the at least one memory 830 may be otherwise configured to, individually or collectively, perform or support such operations.

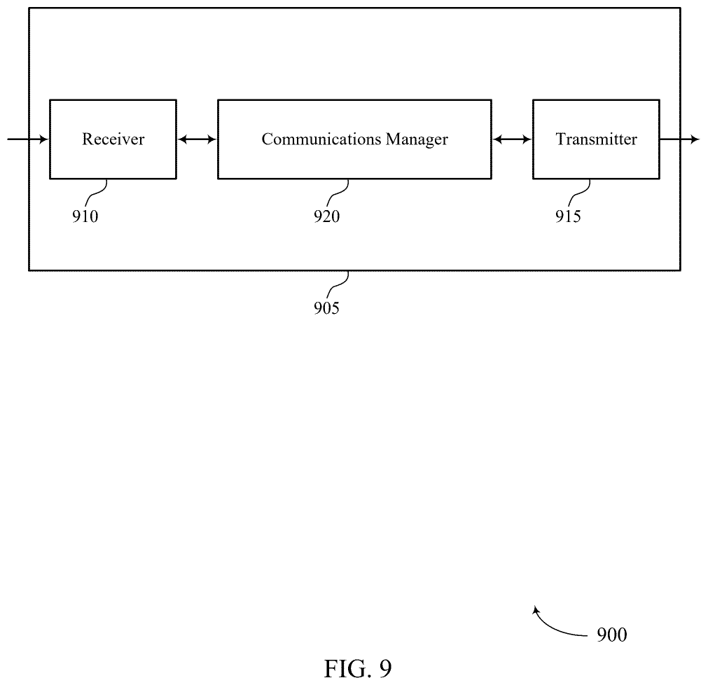

FIG. 9 shows a block diagram 900 of a device 905 that supports methods to mitigate throughput degradation during radio resource management configuration in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of methods to mitigate throughput degradation during radio resource management configuration as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers. The communications manager 920 is capable of, configured to, or operable to support a means for transmitting, to the UE, signaling that indicates a reconfiguration of the one or more measurement resources for the first subset of measurement objects of the set of multiple measurement objects based on the gapless measurement capability of the UE for the first subset of measurement objects.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

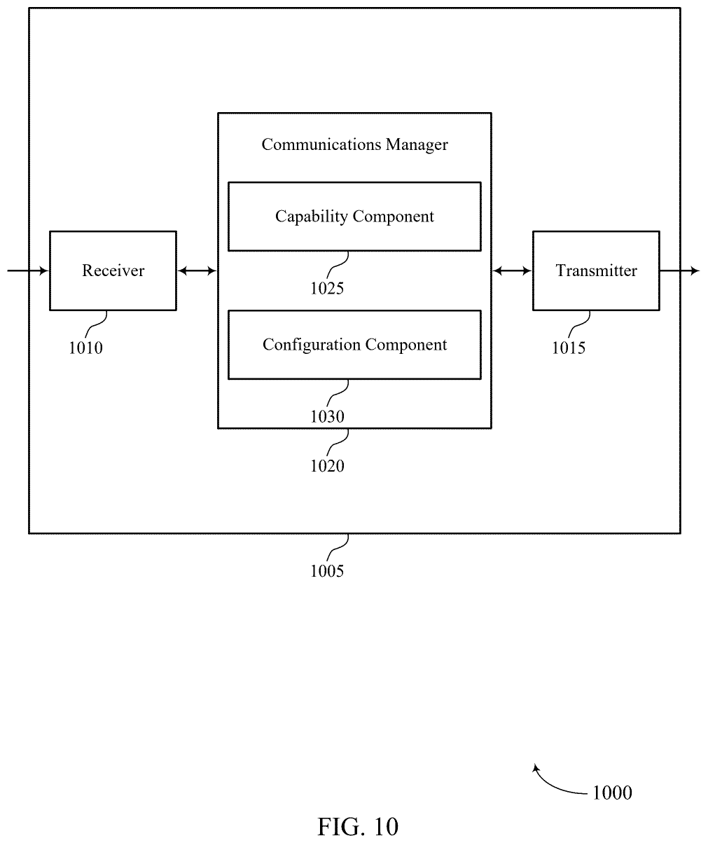

FIG. 10 shows a block diagram 1000 of a device 1005 that supports methods to mitigate throughput degradation during radio resource management configuration in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of methods to mitigate throughput degradation during radio resource management configuration as described herein. For example, the communications manager 1020 may include a capability component 1025 a configuration component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability component 1025 is capable of, configured to, or operable to support a means for receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers. The configuration component 1030 is capable of, configured to, or operable to support a means for transmitting, to the UE, signaling that indicates a reconfiguration of the one or more measurement resources for the first subset of measurement objects of the set of multiple measurement objects based on the gapless measurement capability of the UE for the first subset of measurement objects.

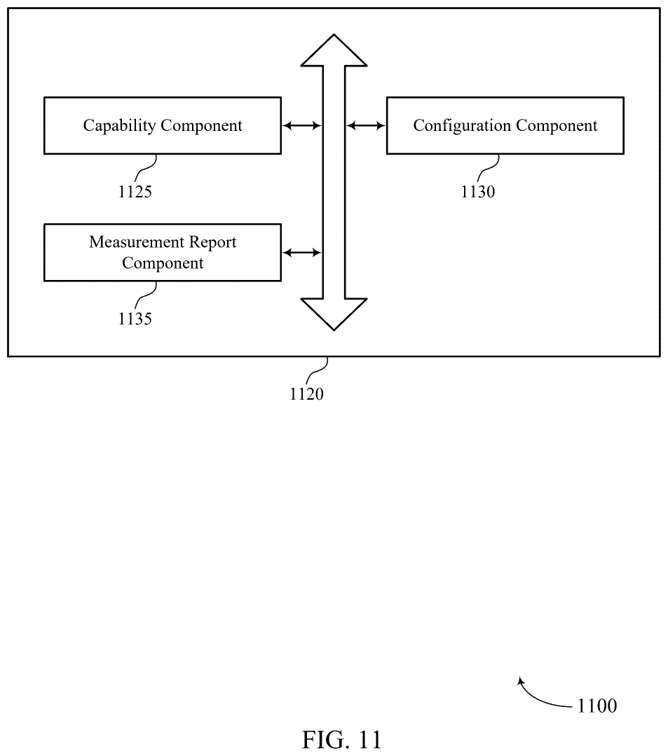

FIG. 11 shows a block diagram 1100 of a communications manager 1120 that supports methods to mitigate throughput degradation during radio resource management configuration in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of methods to mitigate throughput degradation during radio resource management configuration as described herein. For example, the communications manager 1120 may include a capability component 1125, a configuration component 1130, a measurement report component 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability component 1125 is capable of, configured to, or operable to support a means for receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers. The configuration component 1130 is capable of, configured to, or operable to support a means for transmitting, to the UE, signaling that indicates a reconfiguration of the one or more measurement resources for the first subset of measurement objects of the set of multiple measurement objects based on the gapless measurement capability of the UE for the first subset of measurement objects.

In some examples, the measurement report component 1135 is capable of, configured to, or operable to support a means for receiving, from the UE, one or more measurement reports related to the set of multiple measurement objects.

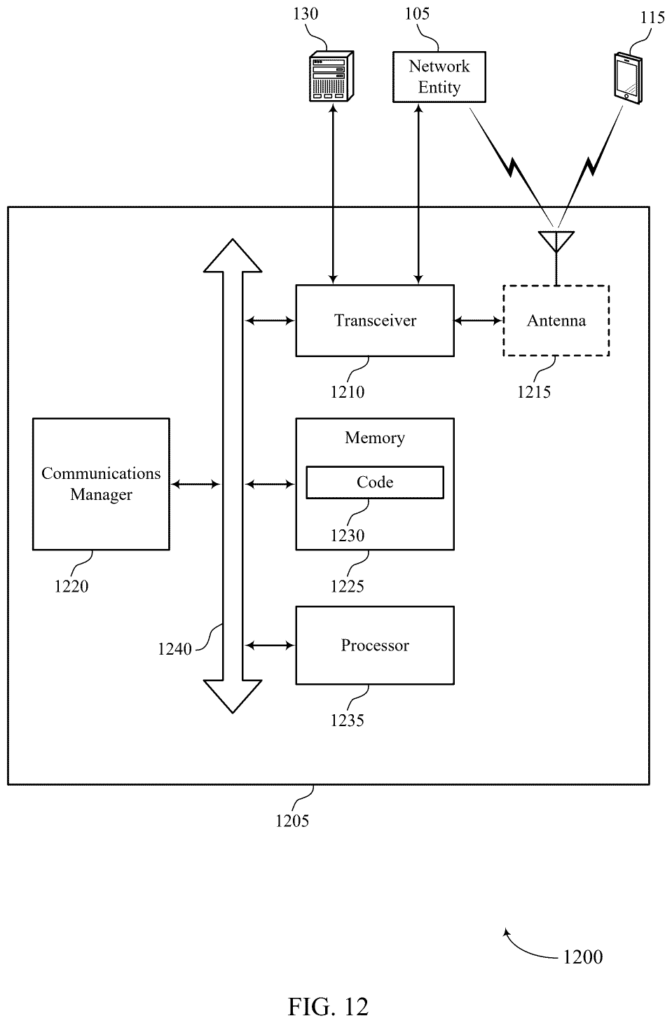

FIG. 12 shows a diagram of a system 1200 including a device 1205 that supports methods to mitigate throughput degradation during radio resource management configuration in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting methods to mitigate throughput degradation during radio resource management configuration). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers. The communications manager 1220 is capable of, configured to, or operable to support a means for transmitting, to the UE, signaling that indicates a reconfiguration of the one or more measurement resources for the first subset of measurement objects of the set of multiple measurement objects based on the gapless measurement capability of the UE for the first subset of measurement objects.

By including or configuring the communications manager 1220 in accordance with examples as described herein, the device 1205 may support techniques for reduced latency, improved throughput, improved user experience related to improved throughput, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of mitigating throughput degradation during radio resource management configuration as described herein, or the at least one processor 1235 and the at least one memory 1225 may be otherwise configured to, individually or collectively, perform or support such operations.

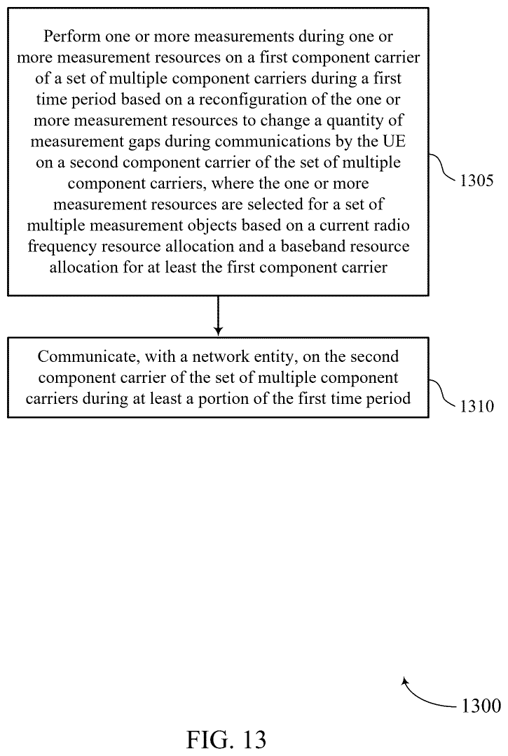

FIG. 13 shows a flowchart illustrating a method 1300 that supports methods to mitigate throughput degradation during radio resource management configuration in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The operations of 1305 may be performed in accordance with examples as disclosed herein. In some examples, aspects of the operations of 1305 may be performed by a measurement component 725 as described with reference to FIG. 7.

At 1310, the method may include communicating, with a network entity, on the second component carrier of the set of multiple component carriers during at least a portion of the first time period. The operations of 1310 may be performed in accordance with examples as disclosed herein. In some examples, aspects of the operations of 1310 may be performed by a communication component 730 as described with reference to FIG. 7.

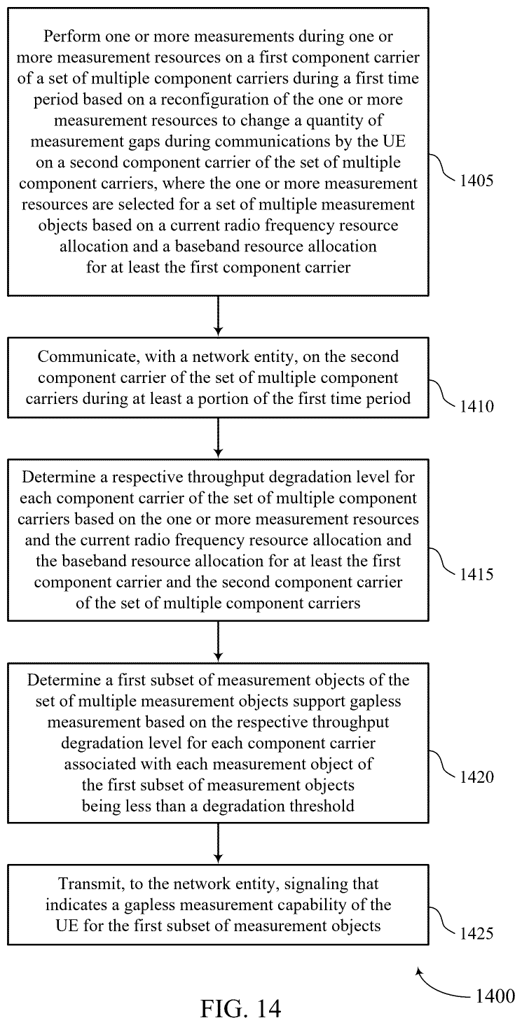

FIG. 14 shows a flowchart illustrating a method 1400 that supports methods to mitigate throughput degradation during radio resource management configuration in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include performing one or more measurements during one or more measurement resources on a first component carrier of a set of multiple component carriers during a first time period based on a reconfiguration of the one or more measurement resources to change a quantity of measurement gaps during communications by the UE on a second component carrier of the set of multiple component carriers, where the one or more measurement resources are selected for a set of multiple measurement objects based on a current radio frequency resource allocation and a baseband resource allocation for at least the first component carrier. The operations of 1405 may be performed in accordance with examples as disclosed herein. In some examples, aspects of the operations of 1405 may be performed by a measurement component 725 as described with reference to FIG. 7.

At 1410, the method may include communicating, with a network entity, on the second component carrier of the set of multiple component carriers during at least a portion of the first time period. The operations of 1410 may be performed in accordance with examples as disclosed herein. In some examples, aspects of the operations of 1410 may be performed by a communication component 730 as described with reference to FIG. 7.

At 1415, the method may include determining a respective throughput degradation level for each component carrier of the set of multiple component carriers based on the one or more measurement resources and the current radio frequency resource allocation and the baseband resource allocation for at least the first component carrier and the second component carrier of the set of multiple component carriers. The operations of 1415 may be performed in accordance with examples as disclosed herein. In some examples, aspects of the operations of 1415 may be performed by a capability component 735 as described with reference to FIG. 7.

At 1420, the method may include determining a first subset of measurement objects of the set of multiple measurement objects support gapless measurement based on the respective throughput degradation level for each component carrier associated with each measurement object of the first subset of measurement objects being less than a degradation threshold. The operations of 1420 may be performed in accordance with examples as disclosed herein. In some examples, aspects of the operations of 1420 may be performed by a capability component 735 as described with reference to FIG. 7.

At 1425, the method may include transmitting, to the network entity, signaling that indicates a gapless measurement capability of the UE for the first subset of measurement objects. The operations of 1425 may be performed in accordance with examples as disclosed herein. In some examples, aspects of the operations of 1425 may be performed by a communication component 730 as described with reference to FIG. 7.

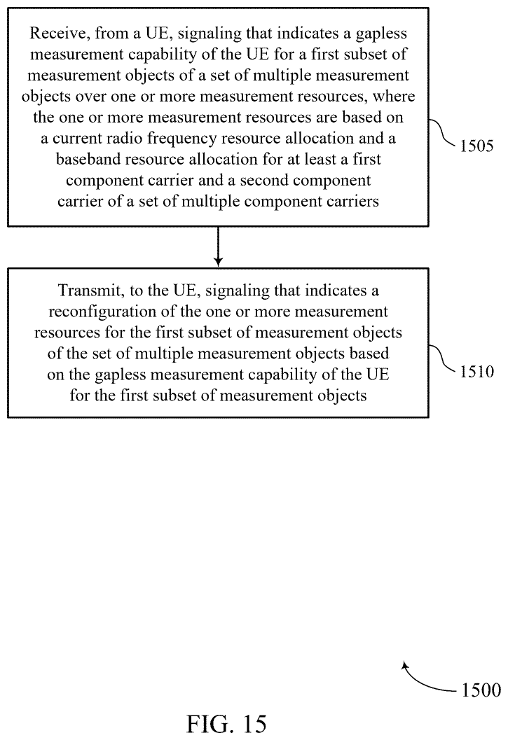

FIG. 15 shows a flowchart illustrating a method 1500 that supports methods to mitigate throughput degradation during radio resource management configuration in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, signaling that indicates a gapless measurement capability of the UE for a first subset of measurement objects of a set of multiple measurement objects over one or more measurement resources, where the one or more measurement resources are based on a current radio frequency resource allocation and a baseband resource allocation for at least a first component carrier and a second component carrier of a set of multiple component carriers. The operations of 1505 may be performed in accordance with examples as disclosed herein. In some examples, aspects of the operations of 1505 may be performed by a capability component 1125 as described with reference to FIG. 11.

At 1510, the method may include transmitting, to the UE, signaling that indicates a reconfiguration of the one or more measurement resources for the first subset of measurement objects of the set of multiple measurement objects based on the gapless measurement capability of the UE for the first subset of measurement objects. The operations of 1510 may be performed in accordance with examples as disclosed herein. In some examples, aspects of the operations of 1510 may be performed by a configuration component 1130 as described with reference to FIG. 11.

The following provides an overview of aspects of the present disclosure:

Aspect 1: A method for wireless communications at a UE, comprising: performing one or more measurements during one or more measurement resources on a first component carrier of a plurality of component carriers during a first time period based on a reconfiguration of the one or more measurement resources to change a quantity of measurement gaps during communications by the UE on a second component carrier of the plurality of component carriers, wherein the one or more measurement resources are selected for a plurality of measurement objects based at least in part on a current radio frequency resource allocation and a baseband resource allocation for at least the first component carrier; and communicating, with a network entity, on the second component carrier of the plurality of component carriers during at least a portion of the first time period.

Aspect 2: The method of aspect 1, wherein the one or more processors are individually or collectively further operable to execute the code to cause the UE to transmitting, to the network entity, signaling that indicates a measurement gap of the one or more measurement of at least one of the plurality of measurement objects of the UE.

Aspect 3: The method of any of aspects 1 through 2, further comprising: determining a respective throughput degradation level for each component carrier of the plurality of component carriers based at least in part on the one or more measurement resources and the current radio frequency resource allocation and the baseband resource allocation for at least the first component carrier and the second component carrier of the plurality of component carriers; determining a first subset of measurement objects of the plurality of measurement objects support gapless measurement based at least in part on the respective throughput degradation level for each component carrier associated with each measurement object of the first subset of measurement objects being less than a degradation threshold; and transmitting, to the network entity, signaling that indicates a gapless measurement capability of the UE for the first subset of measurement objects.

Aspect 4: The method of aspect 3, wherein determining the first subset of measurement objects further comprises: reconfiguring the one or more measurement resources for each measurement object of the first subset of measurement objects.

Aspect 5: The method of aspect 4, further comprising: receiving signaling that reconfigures the one or more measurement resources for the plurality of measurement objects based at least in part on the gapless measurement capability of the UE for the first subset of measurement objects.

Aspect 6: The method of any of aspects 1 through 5, further comprising: determining the reconfiguration of the one or more measurement resources by jointly allocating radio frequency resources and baseband resources from the current radio frequency resource allocation and the baseband resource allocation for the first component carrier and the second component carrier.

Aspect 7: The method of any of aspects 1 through 6, further comprising: determining a respective channel performance for each of the plurality of component carriers, wherein the reconfiguration of the one or more measurement resources is based at least in part on the respective channel performance for each of the plurality of component carriers.

Aspect 8: The method of any of aspects 1 through 7, wherein performance of at least one of the one or more measurements during a pre-reconfiguration state of the UE is during a pre-reconfiguration measurement gap that interferes with communications by the UE on the second component carrier.

Aspect 9: The method of aspect 8, wherein communicating on the second component carrier is during at least the portion of the first time period instead of pausing communications on the second component carrier during the pre-reconfiguration measurement gap.

Aspect 10: The method of any of aspects 1 through 9, wherein the quantity of measurement gaps during communications by the UE on the second component carrier is reduced with respect to a quantity of measurement gaps of a pre-reconfiguration state of the UE.

Aspect 11: A method for wireless communications at a network entity, comprising: receiving, from a UE, signaling that indicates a gapless measurement capability of the UE for a first subset of measurement objects of a plurality of measurement objects over one or more measurement resources, wherein the one or more measurement resources are based at least in part on a current radio frequency resource allocation and a baseband resource allocation for at least a first component carrier and a second component carrier of a plurality of component carriers; and transmitting, to the UE, signaling that indicates a reconfiguration of the one or more measurement resources for the first subset of measurement objects of the plurality of measurement objects based at least in part on the gapless measurement capability of the UE for the first subset of measurement objects.

Aspect 12: The method of aspect 11, further comprising: receiving, from the UE, one or more measurement reports related to the plurality of measurement objects.

Aspect 13: A UE for wireless communications, comprising one or more memories storing processor-executable code, and one or more processors coupled with the one or more memories and individually or collectively operable to execute the code to cause the UE to perform a method of any of aspects 1 through 10.

Aspect 14: A UE for wireless communications, comprising at least one means for performing a method of any of aspects 1 through 10.

Aspect 15: A non-transitory computer-readable medium storing code for wireless communications, the code comprising instructions executable by one or more processors to perform a method of any of aspects 1 through 10.

Aspect 16: A network entity for wireless communications, comprising one or more memories storing processor-executable code, and one or more processors coupled with the one or more memories and individually or collectively operable to execute the code to cause the network entity to perform a method of any of aspects 11 through 12.

Aspect 17: A network entity for wireless communications, comprising at least one means for performing a method of any of aspects 11 through 12.

Aspect 18: A non-transitory computer-readable medium storing code for wireless communications, the code comprising instructions executable by one or more processors to perform a method of any of aspects 11 through 12.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
perform one or more measurements during one or more measurement resources on a first component carrier of a plurality of component carriers during a first time period based on a reconfiguration of the one or more measurement resources to change a quantity of measurement gaps during communications by the UE on a second component carrier of the plurality of component carriers, wherein the one or more measurement resources are selected for a plurality of measurement objects based at least in part on a current radio frequency resource allocation and a baseband resource allocation for at least the first component carrier; and
communicate, with a network entity, on the second component carrier of the plurality of component carriers during at least a portion of the first time period.

2. The UE of claim 1, wherein the one or more processors are individually or collectively further operable to execute the code to cause the UE to:
transmit, to the network entity, signaling that indicates a measurement gap of the one or more measurement at least one of the plurality of measurement objects of the UE.

3. The UE of claim 1, wherein the one or more processors are individually or collectively further operable to execute the code to cause the UE to:
determine a respective throughput degradation level for each component carrier of the plurality of component carriers based at least in part on the one or more measurement resources and the current radio frequency resource allocation and the baseband resource allocation for at least the first component carrier and the second component carrier of the plurality of component carriers;
determine a first subset of measurement objects of the plurality of measurement objects support gapless measurement based at least in part on the respective throughput degradation level for each component carrier associated with each measurement object of the first subset of measurement objects being less than a degradation threshold; and
transmit, to the network entity, signaling that indicates a gapless measurement capability of the UE for the first subset of measurement objects.

4. The UE of claim 3, wherein, to determine the first subset of measurement objects, the one or more processors are individually or collectively further operable to execute the code to cause the UE to:
reconfigure the one or more measurement resources for each measurement object of the first subset of measurement objects.

5. The UE of claim 4, wherein the one or more processors are individually or collectively further operable to execute the code to cause the UE to:
receive signaling that reconfigures the one or more measurement resources for the plurality of measurement objects based at least in part on the gapless measurement capability of the UE for the first subset of measurement objects.

6. The UE of claim 1, wherein the one or more processors are individually or collectively further operable to execute the code to cause the UE to:
determine the reconfiguration of the one or more measurement resources by jointly allocating radio frequency resources and baseband resources from the current radio frequency resource allocation and the baseband resource allocation for the first component carrier and the second component carrier.

7. The UE of claim 1, wherein the one or more processors are individually or collectively further operable to execute the code to cause the UE to:
determine a respective channel performance for each of the plurality of component carriers, wherein the reconfiguration of the one or more measurement resources is based at least in part on the respective channel performance for each of the plurality of component carriers.

8. The UE of claim 1, wherein performance of at least one of the one or more measurements during a pre-reconfiguration state of the UE is during a pre-reconfiguration measurement gap that interferes with communications by the UE on the second component carrier.

9. The UE of claim 8, wherein communicating on the second component carrier is during at least the portion of the first time period instead of pausing communications on the second component carrier during the pre-reconfiguration measurement gap.

10. The UE of claim 1, wherein the quantity of measurement gaps during communications by the UE on the second component carrier is reduced with respect to a quantity of measurement gaps of a pre-reconfiguration state of the UE.

11. A network entity, comprising:
one or more memories storing processor-executable code; and
one or more processors coupled with the one or more memories and individually or collectively operable to execute the code to cause the network entity to:
receive, from a user equipment (UE), signaling that indicates a gapless measurement capability of the UE for a first subset of measurement objects of a plurality of measurement objects over one or more measurement resources, wherein the one or more measurement resources are based at least in part on a current radio frequency resource allocation and a baseband resource allocation for at least a first component carrier and a second component carrier of a plurality of component carriers; and
transmit, to the UE, signaling that indicates a reconfiguration of the one or more measurement resources for the first subset of measurement objects of the plurality of measurement objects based at least in part on the gapless measurement capability of the UE for the first subset of measurement objects.

12. The network entity of claim 11, wherein the one or more processors are individually or collectively further operable to execute the code to cause the network entity to:
receive, from the UE, one or more measurement reports related to the plurality of measurement objects.

13. A method for wireless communications at a user equipment (UE), comprising:
performing one or more measurements during one or more measurement resources on a first component carrier of a plurality of component carriers during a first time period based on a reconfiguration of the one or more measurement resources to change a quantity of measurement gaps during communications by the UE on a second component carrier of the plurality of component carriers, wherein the one or more measurement resources are selected for a plurality of measurement objects based at least in part on a current radio frequency resource allocation and a baseband resource allocation for at least the first component carrier; and
communicating, with a network entity, on the second component carrier of the plurality of component carriers during at least a portion of the first time period.

14. The method of claim 13, wherein the one or more processors are individually or collectively further operable to execute the code to cause the UE to transmitting, to the network entity, signaling that indicates a measurement gap of the one or more measurement of at least one of the plurality of measurement objects of the UE.

15. The method of claim 13, further comprising:
determining a respective throughput degradation level for each component carrier of the plurality of component carriers based at least in part on the one or more measurement resources and the current radio frequency resource allocation and the baseband resource allocation for at least the first component carrier and the second component carrier of the plurality of component carriers;
determining a first subset of measurement objects of the plurality of measurement objects support gapless measurement based at least in part on the respective throughput degradation level for each component carrier associated with each measurement object of the first subset of measurement objects being less than a degradation threshold; and
transmitting, to the network entity, signaling that indicates a gapless measurement capability of the UE for the first subset of measurement objects.

16. The method of claim 15, wherein determining the first subset of measurement objects further comprises:
reconfiguring the one or more measurement resources for each measurement object of the first subset of measurement objects.

17. The method of claim 16, further comprising:
receiving signaling that reconfigures the one or more measurement resources for the plurality of measurement objects based at least in part on the gapless measurement capability of the UE for the first subset of measurement objects.

18. The method of claim 13, further comprising:
determining the reconfiguration of the one or more measurement resources by jointly allocating radio frequency resources and baseband resources from the current radio frequency resource allocation and the baseband resource allocation for the first component carrier and the second component carrier.

19. The method of claim 13, further comprising:
determining a respective channel performance for each of the plurality of component carriers, wherein the reconfiguration of the one or more measurement resources is based at least in part on the respective channel performance for each of the plurality of component carriers.

20. The method of claim 13, wherein performance of at least one of the one or more measurements during a pre-reconfiguration state of the UE is during a pre-reconfiguration measurement gap that interferes with communications by the UE on the second component carrier.
